(19) United States
(12) Patent Application Publication
(10) Pub. No.: US 2022/0159329 A1
(43) Pub. Date: May 19, 2022

(54) ADAPTIVE MEDIA TRAFFIC MANAGEMENT PROCESS

(71) Applicant: Audacy Operations, Inc., Philadelphia, PA (US)

(72) Inventors: Aaron Wright, Philadelphia, PA (US); Richard Schmaeling, Orlando, FL (US)

(73) Assignee: Audacy Operations, Inc., Philadelphia, PA (US)

(21) Appl. No.: 17/525,316

(22) Filed: Nov. 12, 2021

Related U.S. Application Data
(60) Provisional application No. 63/113,425, filed on Nov. 13, 2020.
(60) Provisional application No. 63/184,475, filed on May 5, 2021.

(51) Int. Cl. H04N 21/262

(52) U.S. Cl. CPC H04N 21/26208

(57) ABSTRACT

Systems, methods, and apparatus are described herein for providing an adaptive media traffic management process. The adaptive media traffic management process may be provided to identify available slots in a log, identify unscheduled media information that can be scheduled in the available slots, and determine how to schedule the unscheduled media information to generate a revised (e.g., optimized) log. A computing device may receive a log associated with a media channel from another computing device that is associated with an administrative user. The computing device may identify an available slot. The computing device may automatically assign an unscheduled portion of media information to the available slot. The computing device may generate a revised log that includes the unscheduled portion of media information in the available slot. The computing device may send the revised log to the computing device associated with the administrative user.

### CROSS-REFERENCE TO RELATED APPLICATIONS

This application claims priority to U.S. Provisional Patent Application No. 63/113,425, filed Nov. 13, 2020 and U.S. Provisional Patent Application No. 63/184,475, filed May 5, 2021, which are incorporated herein by reference in their entirety.

### BACKGROUND

Media content providers such as radio stations and networks, television stations and networks, Webcasters, digital publishers, etc., provide programming including media/multimedia content which is the subject of programming. Media content providers' delivery of media/multimedia content is often via broadcasts, unicasts, or multicasts (collectively, “mediacasts”). Programming often includes news reports, sports reports, music (e.g., songs), programs, and advertisements. Portions of the media/multimedia content may occur in segments or slots sometimes referred to as “breaks.” The scheduling of the media/multimedia content is a process conducted periodically (e.g., daily, weekly, etc.) by media content providers.

### SUMMARY

Systems, methods, and apparatus are described herein for providing an adaptive traffic management process. The adaptive media traffic management process may be provided to analyze a media traffic management process (e.g., a media information log) for a media channel and adapting the media traffic management process to include previously unscheduled media information. The adaptive media traffic management process may be provided to initiate an automated method of generating a revised media information log based on one or more algorithms. The adaptive media traffic management process may be provided to use the one or more algorithms to identify available slots in the media information log, identify unscheduled media information that can be scheduled in the available slots, and determine how to schedule the unscheduled media information to generate a revised (e.g., optimized) media information log.

A computing device may receive a log associated with a media channel from another computing device that is associated with an administrative user. The log may indicate a plurality of slots and a plurality of scheduled portions of media information to be broadcast via the media channel in the plurality of slots in a predetermined period. The log may indicate a plurality of codes associated with the scheduled media information. The computing device may receive a list of unscheduled portions of media information. The list may indicate a second plurality of values for the plurality of codes associated with each of the unscheduled portions of media information.

The computing device may identify one or more available slots of the plurality of slots in the predetermined period, for example, based on analysis of the received log. The computing device may remove a plurality of scheduled portions of media information based on a priority code assigned to the respective scheduled portions of media information. The computing device may determine a conflict between each of the unscheduled portions of media information and the available slot(s). The conflict for each of the unscheduled portions of media information may be associated with one or more of the second plurality of values and the plurality of scheduled portions of media information. The computing device may determine, based on analysis of the list, one or more first adjustable constraints associated with the second plurality of values that can be adjusted for one or more of the plurality of unscheduled portions of media information to remove the conflict. The computing device may determine, based on analysis of pre-determined settings for each of the plurality of unscheduled portions of media information, a modification range for each of the one or more first adjustable constraints.

The computing device may adjust, based on the plurality of scheduled portions of media information and the available slot, at least one of the one or more first adjustable constraints within the respective modification range to generate one or more first adjusted constraints. The computing device may assign (e.g., automatically assign), based on analysis of the second plurality of values, the first plurality of codes, and the one or more first adjusted constraints, a first unscheduled portion of the plurality of unscheduled portions of media information to the available slot. The computing device may generate a revised log that comprises the first unscheduled portion of media information in the available slot. The computing device may send the revised log to the computing device associated with the administrative user.

One or more scheduled portions of media information may be moved to one or more available slot(s), for example, to better accommodate the unscheduled portions of media information. For example, the unscheduled portions of media information may be assigned to the slots vacated by the one or more scheduled portions of media information that were moved to the one or more available slots. A code may be added to the plurality of codes for the unscheduled media information and/or the scheduled media information. The added code may enable adjustment of a related constraint (e.g., a time based constraint) such that unscheduled media information can be assigned to the one or more available slots. One or more scheduled portions of media information and/or one or more unscheduled portions of media information may be moved to a future log, for example, to create additional available slots and/or reduce the number of unscheduled portions of media information.

### BRIEF DESCRIPTION OF THE DRAWINGS

FIG. 1 illustrates a block diagram of an example computing device.

FIG. 2 illustrates a block diagram of an example computing network system.

FIG. 3 is a flow diagram illustrating an example method that may be implemented to generate a revised media information log.

FIG. 4 is a flow diagram illustrating another example method for generating a revised media information log.

FIG. 5 is a flow diagram illustrating an example method for generating a revised media information log by moving scheduled media information to an available slot.

FIG. 6 is a flow diagram illustrating an example method for generating a revised media information log by adding a code.

FIG. 7 is a flow diagram illustrating an example method for generating a revised media information log by moving scheduled information to another media information log.

### DETAILED DESCRIPTION

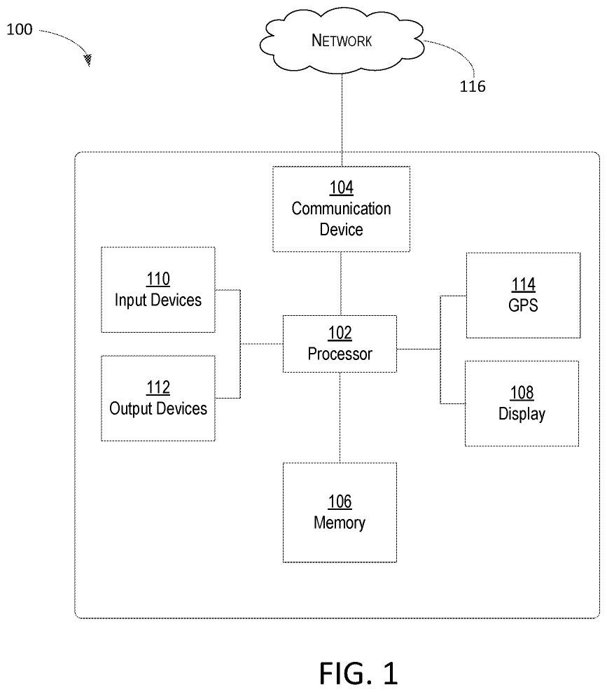

FIG. 1 illustrates a block diagram of an example computing device 100. The computing device 100 may include a personal computer, such as a laptop or desktop computer, a tablet device, a cellular phone or smartphone, a server, or another type of computing device. The computing device 100 may include a processor 102, a communication interface 104, a memory 106, a display 108, input devices 110, output devices 112, and/or a GPS circuit 114. The computing device 100 may include additional, different, or fewer components.

The processor 102 may include one or more general purpose processors, special purpose processors, conventional processors, digital signal processors (DSPs), microprocessors, integrated circuits, a programmable logic device (PLD), application specific integrated circuits (ASICs), or the like. The processor 102 may perform signal coding, data processing, image processing, power control, input/output processing, and/or any other functionality that enables the computing device 100 to perform as described herein.

The processor 102 may store information in and/or retrieve information from the memory 106. The memory 106 may include a non-removable memory and/or a removable memory. The non-removable memory may include random-access memory (RAM), read-only memory (ROM), a hard disk, or any other type of non-removable memory storage. The removable memory may include a subscriber identity module (SIM) card, a memory stick, a memory card, or any other type of removable memory. The memory may be local memory or remote memory external to the computing device 100. The memory 106 may store instructions which are executable by the processor 102. Different information may be stored in different locations in the memory 106.

The processor 102 that may communicate with other devices via the communication device 104. The communication device 104 may transmit and/or receive information over the network 116, which may include one or more other computing devices. The communication device 104 may perform wireless and/or wired communications. The communication device 104 may include a receiver, transmitter, transceiver, or other device capable of performing wireless communications via an antenna. The communication device 104 may be capable of communicating via one or more protocols, such as a cellular communication protocol, a Wi-Fi communication protocol, Bluetooth®, a near field communication (NFC) protocol, an internet protocol, another proprietary protocol, or any other radio frequency (RF) or communications protocol. The computing device 100 may include one or more communication devices 104.

The processor 102 may be in communication with a display 108 for providing information to a user. The information may be provided via a user interface on the display 108. The information may be provided as an image generated on the display 108. The display 108 and the processor 102 may be in two-way communication, as the display 106 may include a touch-screen device capable of receiving information from a user and providing such information to the processor 102.

The processor 102 may be in communication with a GPS circuit 114 for receiving geospatial information. The processor 102 may be capable of determining the GPS coordinates of the wireless communication device 100 based on the geospatial information received from the GPS circuit 114. The geospatial information may be communicated to one or more other communication devices to identify the location of the computing device 100.

The processor 102 may be in communication with input devices 110 and/or output devices 112. The input devices 110 may include a camera, a microphone, a keyboard or other buttons or keys, and/or other types of input devices for sending information to the processor 102. The display 108 may be a type of input device, as the display 108 may include touch-screen sensor capable of sending information to the processor 102. The output devices 112 may include speakers, indicator lights, or other output devices capable of receiving signals from the processor 102 and providing output from the computing device 100. The display 108 may be a type of output device, as the display 108 may provide images or other visual display of information received from the processor 102.

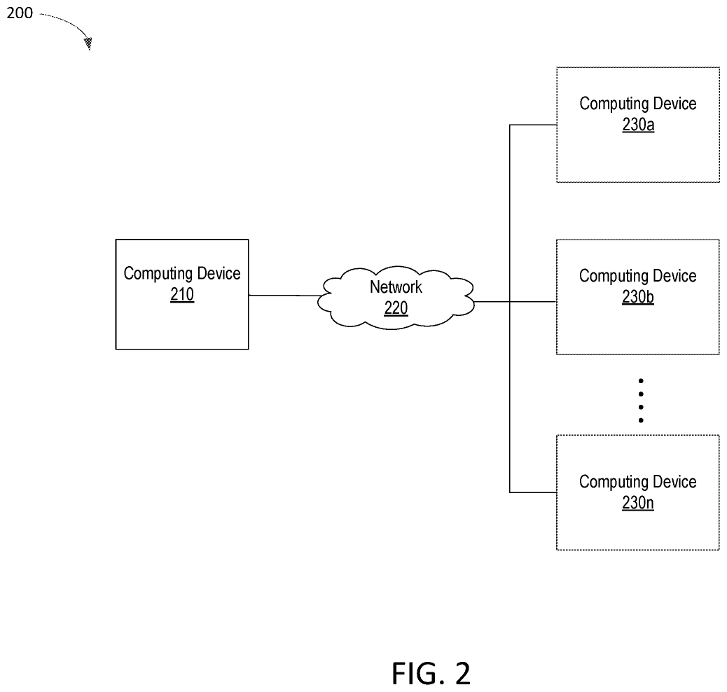

FIG. 2 illustrates a block diagram of an example computing network system 200. The computing network system 200 may include one or more computing devices 230a-230n that may be capable of communicating digital messages with one another, either directly or via the network 220. The computing devices 230-230n may be user devices capable of logging into a session of an interactive computing environment and providing real-time interactive data via the network 220. The network 220 may include a wired and/or wireless network. For example, the network 220 may include a Wi-Fi communication network, a Wi-MAX communication network, a cellular communication network (e.g., CDMA, HSPA+, LTE, etc.), and/or a television white space (TVWS) communication network. The network 220 may include one or more communication networks.

The one or more computing devices 230a-230n may be capable of communicating digital messages to and/or receiving digital messages from the computing device 210 via the network 220. The computing device 210 may be a server, such as a web server, for providing a user interface to the computing devices 230a-230n. The computing device 210 may be in communication with an application executing locally on the computing devices 230a-230n for providing a user interface at the computing devices. The display of information may be generated locally at the computing devices 230a-230n or at the computing device 210 and provided via an application (e.g., a web browser) at the computing devices 230a-230n.

One or more of the computing devices 230a-230n may be operated by an administrative user capable of configuring sessions of an interactive computing environment that may be stored at the computing device 210. The computing device operated by the administrative user may submit credentials to the computing device 210 to allow the session to be configured. The session may be accessed by the computing devices 230a-230n via the network 220.

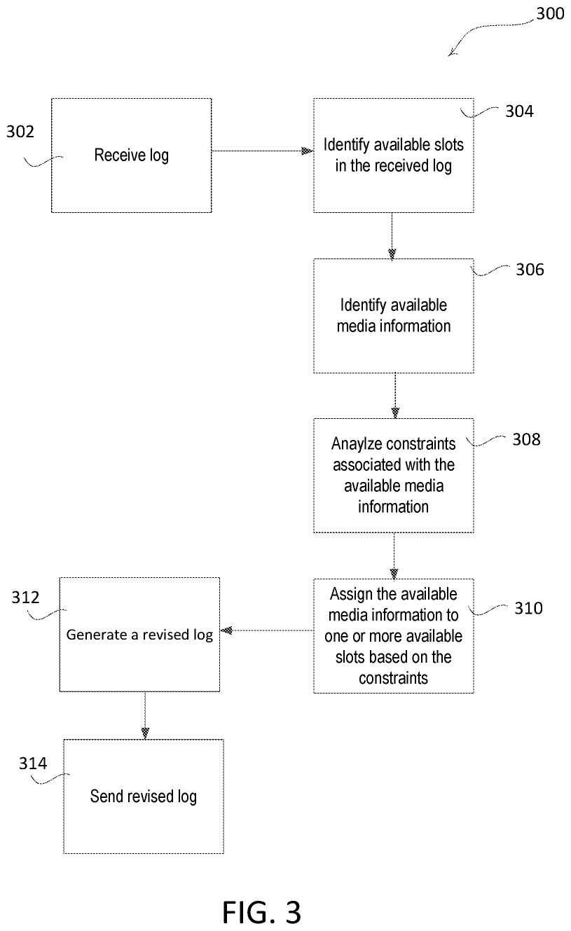

FIG. 3 is a flow diagram of an example method 300 that may be implemented by a computing device (e.g., such as the computing devices 230a-230n shown in FIG. 2) to generate a revised media information log. The method 300, or portions thereof, may be performed to enable adaptive media traffic management of a media channel. The adaptive media traffic management may include placement of media information in slots of a media information log. Media information may include news reports, sports reports, music (e.g., songs), programs, and/or advertisements. The method 300, or portions thereof, may be performed at a single computing device or may be distributed across multiple computing devices (e.g., a server and a user device). The method 300, or portions thereof, may be performed to enable users, such as administrative users, to identify available slots, available media information, and assign the available media information to the available slots. The method 300, or portions thereof, may be performed to enable adaptive generation of a revised media information log that includes the available media information, or portions thereof, in respective slots. The method 300, or portions thereof, may reduce the amount of processing resources used by the computing device during a predetermined period (e.g., day). The method 300, or portions thereof, may improve the functionality of a computer network system (e.g., such as the computing network system 200 shown in FIG. 2) associated with the adaptive media traffic management of the media channel. In addition, the method 300, or portions thereof, implement a distributed network architecture, as shown in FIG. 2, to reduce the amount of signaling between the computing device and an administrative computing device (e.g., such as the computing device 210 shown in FIG. 2) and reduce the amount of processing resources consumed by the administrative computing device.

As illustrated in FIG. 3, a computing device may receive, at 302, a media information log. The media information log may be associated with a media channel. The media channel may be a radio station, a radio network, a television station, a television network, a webcast, a streaming station, a streaming channel, a digital publisher, a social media channel, a social media platform, and/or the like. The media information log may be received from another computing device (e.g., such as the computing device 210 shown in FIG. 2). The other computing device may be associated with an administrative user. The computing device may receive the media information log via a wireless connection with the other computing device or via a wired connection with the other computing device. For example, the computing device may receive the media information log from the other computing device via a network (e.g., such as the network 220 shown in FIG. 2). The media information log may indicate slots (e.g., time slots) and scheduled portions of media information assigned to the slots for a predetermined period (e.g., a 24 hour period or a day). Each of the slots may be associated with a portion of the predetermined period. For example, each of the slots may represent even or uneven segments of the predetermined period. In examples, each slot is assigned a length of time according to the daily schedule. In examples, each slot is assigned the same length of time (e.g., 10 seconds) and slots are combined to create slots having a longer length. Each of the scheduled portions of media information may be scheduled to be broadcast via the media channel in their respective slots. A scheduled portion of media information may include a news report, music (e.g., a song), a weather forecast, a program, and/or an advertisement.

Each of the scheduled portions of media information may be associated with a plurality of codes. The media information log may indicate the plurality of codes. For example, the media information log may indicate values for each of the scheduled portions of media information for the plurality of codes. The plurality of codes may indicate one or more characteristics associated with the corresponding scheduled portions of media information. For example, the plurality of codes may include one or more of a priority code, a product code, a day locked code, a slot locked code, a media information type code, a position code, a block detail code, a slot number code, an advertiser separation code, a brand separation code, a product separation code, a length code, an exclusivity code, or a rate code. The priority code may indicate a priority (e.g., a relative priority) assigned to the media information. For example, the priority code may indicate which media information has a higher priority than other media information. Table 1 provides example priority codes for example media information.

TABLE 1
Example Priority Codes

| Example Portions of Media | |
|---|---|
| Information | Priority Code |
| Portion A | 0 |
| Portion B | 1 |
| Portion C | 2 |
| Portion D | 2 |
| Portion E | 3 |

In the example shown in Table 1, the lowest the value of the priority code may represent the lowest priority and the highest value of the priority code may represent the highest priority. As shown in Table 1, two or more portions of media information may have the same priority code. The product code may indicate a product category associated with the media information. For example, the product code may indicate whether a product associated with the media information is a soft drink, an automobile dealer, a contractor, a school, a bank, an insurance company, a cell phone, and/or the like. The day locked code may indicate whether the media information is locked to a specific day (e.g., the current media information log). For example, the day locked code may indicate whether the media information can be broadcast on another day (e.g., media information log) or must be broadcast on the day associated with the received media information log. The slot locked code may indicate whether the media information is restricted to the assigned (e.g., scheduled) slot. For example, the slot locked code may indicate whether the media information can be moved to another slot in the received media information log. The media information type code may indicate a type of media information. For example, the media information type code may indicate whether the media information is a news report, music (e.g., a song), a weather forecast, a program, or an advertisement.

The position code may indicate an assigned position for the media information within a block. A block may include a plurality of slots. For example, the block may include a plurality of slots associated with media information having the same media information type. The block may be an advertisement block, a news block, a music block, a weather block, a sports block, a program block, or another type of block. An advertisement block may be referred to as a break (e.g., a commercial break). A block of one type may be followed by a block of another type. For example, a program block may be followed by an advertisement block. In addition, a block of a specific type may be followed by a block of the same type. For example, an advertisement block may be followed by another advertisement block.

The block detail code may indicate a specific block and/or a specific block type for the media information. For example, each block in the log may be assigned a block detail code. A specific portion (e.g., scheduled or unscheduled) of media information may be constrained to a specific block and/or block type using the block detail code. For example, each portion of unscheduled media information may be assigned a block detail code. The block detail code may restrict combination of time in adjacent blocks. For example, if adjacent blocks have different block detail codes, time from those adjacent blocks cannot be combined to create a slot with a longer duration. The block detail code to the plurality of codes may avoid assigning a portion of available media information to a block with break details that do not match the portion of available media information. The block detail code may prevent combination of time in adjacent blocks with different break detail codes. Adding the block detail code may enable combination of time in adjacent blocks having the same block detail code to create a new slot (e.g., a new available slot) and/or extend the duration of an available slot. For example, 5 seconds from a first block may be combined with 25 seconds from a second block to create a 30 second slot when the first block and the second block have the same block detail code.

The slot number code may indicate a specific slot for the media information. For example, the slot number code may be used for media information that is locked to the specific slot. The advertiser separation code may indicate that the media information should be separated from other media information associated with the same advertiser. The advertiser separation code may be a time based separation code. For example, the advertiser separation code may indicate a length of time that two portions of media information from a specific advertiser should be separated. The advertiser separation code may be a block based separation code. For example, the advertiser separation code may indicate that two portions of media information from a specific advertiser should not be assigned to slots in the same block. The brand separation code may indicate that the media information should be separated from other media information associated with a competitor advertiser and/or a competitor product. The brand separation code may be a time based separation code. For example, the brand separation code may indicate a length of time that a portion of media information from a specific advertiser should be separated from other media information associated with the competitor advertiser and/or the competitor product. The brand separation code may be a block based separation code. For example, the brand separation code may indicate that a portion of media information from a specific advertiser should not be assigned to a slot in the same block as another portion of media information from a competitor advertiser and/or competitor product.

The product separation code may indicate that the media information should be separated from other media information associated with a similar product type. The product separation code may be a time based separation code. For example, the product separation code may indicate a length of time that a portion of media information associated with a product type should be separated from another portion of media information associated with the same or similar product type. The product separation code may be a block based separation code. For example, the product separation code may indicate that the portion of media information should not be assigned within the same block as another portion of media information that is associated with the same or a similar product type. The length code may indicate a length of media information. The exclusivity code may indicate whether media information should not be placed in the same block or hour as other media information associated with the same product type. The rate code may indicate a revenue rate associated with the media information.

Additionally or alternatively, a portion of media information may be associated with one or more restricted times and/or days. For example, the portion of media information may be restricted from being assigned to one or more restricted times and/or days. The restricted times and/or days for each portion of media information may be indicated in the media information log, for example, using a restricted time indication. The restricted time indication may indicate one or more times and/or days in which the respective portion of media information can or cannot be assigned.

The computing device may identify, at 304, one or more available slots in the received media information log. For example, the received media information log may indicate that media information is not assigned to the one or more available slots. The computing device may analyze the received media information log to determine the one or more available slots. For example, the computing device may identify, at 304, based on analysis of the received media information log, the one or more available slots in the predetermined period. The computing device may identify, at 304, an available slot based on a determination of unscheduled time in adjacent blocks having the same block detail code, as described herein. For example, the computing device may determine that unscheduled time in adjacent blocks can be combined (e.g., when the adjacent blocks have the same block detail code) to create an available slot.

Additionally or alternatively, the computing device may remove scheduled media information having a priority (e.g., priority code) below a threshold priority (e.g., threshold priority code) from the media information log. For example, the computing device may remove the low priority scheduled media information prior to identifying, at 304, the available slot(s) in the media information log such that the slots vacated by the removed scheduled media information are determined to be available slots. The computing device may use the priority code(s) assigned to the scheduled media information to determine which media information to remove from the media information log. The removal from the media information log of scheduled media information having a priority code below a threshold priority code may be performed automatically by the computing device, for example, upon receipt of the media information log. Removing the low priority scheduled media information may result in time savings in generating a revised log, reduce the number of calculations performed to generate the revised log, and/or improve processor efficiency.

At 306, the computing device may receive an unscheduled media information list. The unscheduled media information list may indicate one or more (e.g., a plurality of) available (e.g., unscheduled portions of) media information. The available media information may be available to schedule in the one or more available slots in the predetermined period. The unscheduled media information list may indicate values of the plurality of codes for the available media information. An available (e.g., unscheduled) portion of media information may include a news report, music (e.g., a song), a weather forecast, a program, and/or an advertisement.

At 308, the computing device may analyze constraints associated with the available media information. For example, the computing device may store a list of constraints for one or more of the plurality of codes. The constraints in the list may have values that differ from the values indicated in the unscheduled media information list. The computing device may compare the constraints (e.g., the values of the constraints) against the values indicated in the unscheduled media information list.

At 310, the computing device may assign (e.g., automatically assign) one or more portions of the available media information to the one or more available slots. For example, the computing device may assign the available media information to the available slots based on the stored constraints (e.g., comparison of the constraints and the values indicated in the unscheduled media information list). The computing device may identify one or more of the values indicated in the unscheduled media information list that can be adjusted such that the available media information associated with the one or more values can be assigned to an available slot. For example, the computing device may adjust the one or more values indicated in the unscheduled media information toward the values of the constraints until the available media information can be assigned to an available slot. Additionally or alternatively, the computing device may assign the available media information to the available slot(s) based on a match between the break detail code of the available slot and the break detail code of the available media information.

At 312, the computing device may generate a revised media information log. The revised media information log may include one or more portions of the available media information in the one or more available slots. The computing device may determine a start date and/or an end date for the revised media information log. For example, the computing device may determine how long the revised media information log should be used.

The predetermined period may be adjustable. For example, the computing device may determine an end (e.g., a length) of the predetermined period. The computing device may determine the end of the predetermined period based on a user input. The end of the predetermined period may comprise an end date. Additionally or alternatively, the computing device may determine a start of the predetermined period. The computing device may determine the end of the predetermined period based on a user input. The start of the predetermined period may comprise a start date. For example, a user may determine whether to lengthen or shorten the predetermined period. By adjusting the start date and/or end date, the computing device can determine how long to use the revised media information log. Additionally or alternatively, the computing device may determine whether to lengthen or shorten the predetermined period.

After generating the revised media information log, at 312, the computing device may perform a recycle procedure. As part of the recycle procedure, the computing device may identify unplaced media information. The unplaced media information may include available media information that was not placed in the revised information log and/or previously scheduled media information that was displaced from the revised information log. The recycle procedure may include repeating the example method 300. For example, the computing device may be configured to repeat steps 304-312 of the example method 300 in the recycle procedure. The recycle procedure may be used by the computing device to determine whether available media information and/or displaced media information can be scheduled in the revised media information log. For example, the recycle procedure may be used by the computing to determine whether media information displaced later in the predetermined period (e.g., a later day in the predetermined period) can be scheduled earlier in the predetermined period (e.g., an earlier day in the predetermined period). The computing device may identify one or more portions of displaced media information that can be scheduled in an earlier slot (e.g., earlier in the predetermined period than the slot from which the one or more portions of displaced media information were displaced from) of the revised information log.

At 314, the computing device may send the revised media information log to another computing device (e.g., the computing device that sent the initial media information log) associated with the administrative user. The computing device may send the revised media information log via the wireless connection with the other computing device or via the wired connection with the other computing device. The computing device may include one or more of the start date or the end date to the other computing device, for example, with the revised media information log. For example, the computing device may send the revised media information log to the other computing device via the network (e.g., such as the network 220 shown in FIG. 2).

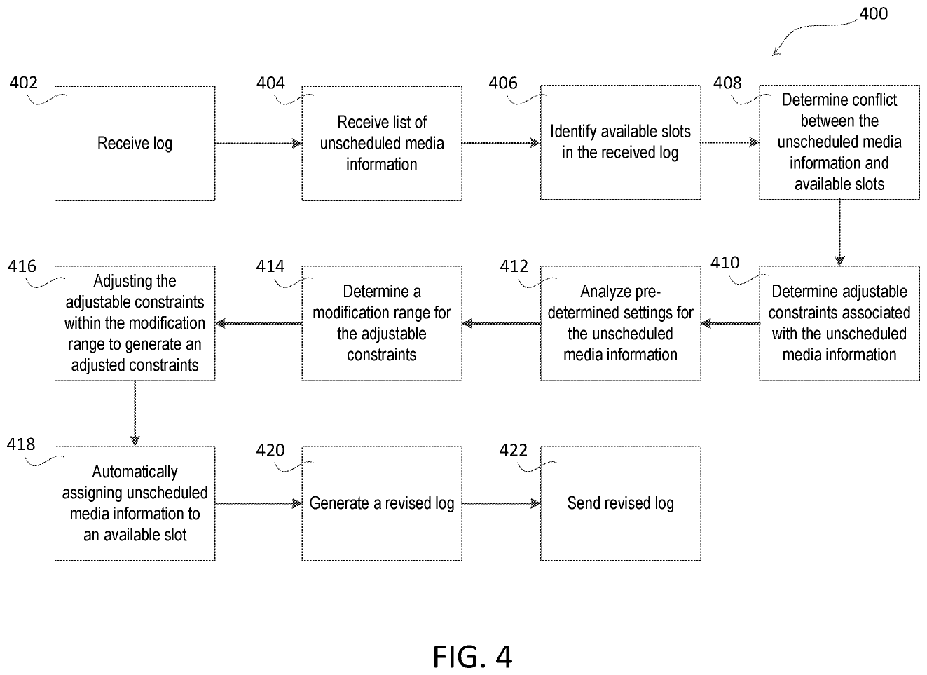

FIG. 4 is a flow diagram of an example method 400 that may be implemented by a computing device (e.g., such as the computing devices 230a-230n shown in FIG. 2) to generate a revised media information log. The method 400, or portions thereof, may be performed to enable adaptive media traffic management of a media channel. The adaptive media traffic management may include placement of media information in slots of a media information log. Media information may include news reports, sports reports, music (e.g., songs), programs, and/or advertisements. The method 400, or portions thereof, may be performed at a single computing device or may be distributed across multiple computing devices (e.g., a server and a user device). The method 400, or portions thereof, may be performed to enable users, such as administrative users, to identify available slots, available media information, and assign the available media information to the available slots. The method 400, or portions thereof, may be performed to enable adaptive generation of a revised media information log that includes the available media information, or portions thereof, in respective slots. The method 400, or portions thereof, may reduce the amount of processing resources used by the computing device during a predetermined period (e.g., day). The method 400, or portions thereof, may improve the functionality of a computer network system (e.g., such as the computing network system 200 shown in FIG. 2) associated with the adaptive media traffic management of the media channel. In addition, the method 400, or portions thereof, implement a distributed network architecture, as shown in FIG. 2, to reduce the amount of signaling between the computing device and an administrative computing device (e.g., such as the computing device 210 shown in FIG. 2) and reduce the amount of processing resources consumed by the administrative computing device. The method 400, or portions thereof, may be combined with the method 300.

As illustrated in FIG. 4, a computing device may receive, at 402, a media information log. The media information log may be associated with a media channel. The media channel may be a radio station, a radio network, a television station, a television network, a webcast, a streaming station, a streaming channel, a digital publisher, a social media channel, a social media platform, and/or the like. The media information log may be received from another computing device (e.g., such as the computing device 210 shown in FIG. 2). The other computing device may be associated with an administrative user. The computing device may receive the media information log via a wireless connection with the other computing device or via a wired connection with the other computing device. For example, the computing device may receive the media information log from the other computing device via a network (e.g., such as the network 220 shown in FIG. 2). The media information log may indicate slots (e.g., time slots) and scheduled portions of media information assigned to the slots for a predetermined period (e.g., a 24 hour period or a day). Each of the slots may be associated with a portion of the predetermined period. For example, each of the slots may represent even or uneven segments of the predetermined period. In examples, each slot is assigned a length of time according to the daily schedule. In examples, each slot is assigned the same length of time (e.g., 10 seconds) and slots are combined to create slots having a longer length. Each of the scheduled portions of media information may be scheduled to be broadcast via the media channel in their respective slots. A scheduled portion of media information may include a news report, music (e.g., a song), a weather forecast, a program, and/or an advertisement.

Each of the scheduled portions of media information may be associated with a plurality of codes. The media information log may indicate the plurality of codes. For example, the media information log may indicate values for each of the scheduled portions of media information for the plurality of codes. The plurality of codes may indicate one or more characteristics associated with the corresponding scheduled portions of media information. For example, the plurality of codes may include one or more of a priority code, a product code, a day locked code, a slot locked code, a media information type code, a position code, a break detail code, a slot number code, an advertiser separation code, a brand separation code, a product separation code, a length code, an exclusivity code, or a rate code.

At 404, the computing device may receive an unscheduled media information list. The unscheduled media information list may indicate one or more (e.g., a plurality of) available (e.g., unscheduled portions of) media information. The available media information may be available to schedule in the one or more available slots in the predetermined period. The unscheduled media information list may indicate values of the plurality of codes for each of the portions of available media information. An available (e.g., unscheduled) portion of media information may include a news report, music (e.g., a song), a weather forecast, a program, and/or an advertisement.

The computing device may identify, at 406, one or more available slots in the received media information log. For example, the received media information log may indicate that media information is not assigned to the one or more available slots. The computing device may analyze the received media information log to determine the one or more available slots. For example, the computing device may identify, at 406, based on analysis of the received media information log, the one or more available slots in the predetermined period. The computing device may identify, at 406, an available slot based on a determination of unscheduled time in adjacent blocks having the same block detail code, as described herein. For example, the computing device may determine that unscheduled time in adjacent blocks can be combined (e.g., when the adjacent blocks have the same block detail code) to create an available slot.

Additionally or alternatively, the computing device may remove scheduled media information having a priority (e.g., priority code) below a threshold priority (e.g., threshold priority code) from the media information log. For example, the computing device may remove the low priority scheduled media information prior to identifying, at 406, the available slot(s) in the media information log such that the slots vacated by the removed scheduled media information are determined to be available slots. The removal from the media information log of scheduled media information having a priority code below a threshold priority code may be performed automatically by the computing device, for example, upon receipt of the media information log. Removing the low priority scheduled media information may result in time savings in generating a revised log, reduce the number of calculations performed to generate the revised log, and/or improve processor efficiency.

At 408, the computing device may determine one or more conflicts between the available media information and the one or more available slots. The conflicts may be associated with one or more scheduled portions of media information proximate to an available slot. One or more scheduled portions of media information within the same block, the same hour block, and/or a predetermined period may be considered to be proximate to the available slot. For example, the conflicts may be associated with values of the plurality of codes for the available media information and values of the plurality of codes for scheduled media information proximate to the respective available slots. The computing device may determine, at 408, a conflict for a portion of available media information for an available slot based on a comparison of the values of the plurality of codes for the portion of available media information and the values of the plurality of codes for scheduled portions of media information proximate to the available slot.

When the length of the available slot is less than the length of a portion of available media information, the computing device may determine a length conflict between the available slot and the portion of available media information. When a time separation between the available slot and a scheduled portion of media information associated with a related product is less than a value for the product separation code associated with a portion of available media information, the computing device may determine a product conflict between the available slot and the portion of available media information. The computing device may determine that a product is related based on the product code. When a time separation between the available slot and a scheduled portion of media information associated with a competitor advertiser is less than a value for the advertiser separation code associated with a portion of available media information, the computing device may determine an advertiser conflict between the available slot and the portion of available media information. When a time separation between the available slot and a scheduled portion of media information associated with a related brand is less than a value for the brand separation code associated with a portion of available media information, the computing device may determine a brand conflict between the available slot and the portion of available media information. When a time separation between the available slot and a scheduled portion of media information associated with an advertiser associated with a portion of available media information is less than a value for the product separation code associated with the portion of available media information, the computing device may determine an advertiser conflict between the available slot and the portion of available media information.

When the available slot is in the same block as a scheduled portion of media information associated with an advertiser associated with a portion of available media information, the computing device may determine an advertiser conflict between the available slot and the portion of available media information. When the available slot is in the same block as a scheduled portion of media information associated with a competitor advertiser associated with a portion of available media information, the computing device may determine an advertiser conflict between the available slot and the portion of available media information. When the available slot is in the same block as a scheduled portion of media information associated with a competitor product associated with a portion of available media information, the computing device may determine a product conflict between the available slot and the portion of available media information. When the available slot is in the same block as a scheduled portion of media information associated with a brand associated with a portion of available media information, the computing device may determine a brand conflict between the available slot and the portion of available media information.

At 410, the computing device may determine, for each of the determined conflicts, one or more adjustable constraints associated with the values of the plurality of codes indicated for the available media information. The one or more adjustable constraints may include time based separation constraints associated with the block based separation codes and/or block based separation constraints associated with the block based separation codes. The one or more adjustable constraints may be adjusted for one or more of the unscheduled portions of media information, for example, to remove the conflict. For example, the computing device may determine that a time based separation and/or a block based separation associated with the available media information and the available slots can be adjusted. In examples, the computing device may determine that a length (e.g., 5 minutes) of the time based separation constraint can be adjusted. In examples, the computing device may determine that a block based separation constraint can be adjusted. For example, the computing device may determine that a block based separation constraint can be converted to a time based separation constraint.

At 412, the computing device may analyze one or more pre-determined settings for the available media information. For example, the computing device may store the pre-determined settings for the available media information. The computing device may also store pre-determined settings for the scheduled media information. The pre-determined settings may represent a limit (e.g., an adjustment limit) for the values of the plurality of codes. For example, the pre-determined settings may (e.g., and the limit) for each of the values of the plurality of codes for a specific portion of media information may be based on contractual obligations associated with an advertiser of the specific portion of media information. The computing device may include a memory system having programmable operational characteristics that are configurable based on the pre-determined settings for the available media information. For example, the memory system may store specific operational characteristics for each portion of available media information. The computing device may update the operational characteristics periodically.

At 414, the computing device may determine a modification range for the adjustable constraints. The modification range may be determined, at 414, based on the pre-determined settings. For example, the modification range may be determined as the range between the values indicated in the available media information list and the limit stored in the pre-determined settings. The available media information list may indicate a value for each of the plurality of codes for a specific portion of available media information. The computing device may determine modification ranges for one or more of the plurality of codes based on the limits stored for each of the plurality of codes associated with the specific portion of available media information.

At 416, the computing device may adjust one or more of the adjustable constraints. The computing device may adjust, at 416, the adjustable constraint(s) to generate one or more adjusted constraints. The computing device may adjust, at 416, the adjustable constraint(s) based on the respective determined modification range. The computing device may adjust, 416, the adjustable constraint(s) to remove (e.g., negate) the determined conflict such that the available media information can be assigned to the available slot(s). For example, the computing device may adjust an adjustable constraint for a portion of available media information within the modification range such that the portion of available media information can be assigned to a specific available slot. When a plurality of portions of available media information are conflicted from a specific available slot, the computing device may adjust, at 416, one or more constraints for each of the plurality of portions of available media information.

At 418, the computing device may assign (e.g., automatically assign) a portion of available media information to the available slot(s). The computing device may determine (e.g., automatically determine) which portion(s) of available media information to assign to the available slot(s), for example, when conflicts associated with an available slot and more than one portion of available media information have been negated. For example, the computing device may include an algorithm that determines which portions(s) of the available media information to assign to the available slot(s). Stated differently, the algorithm may adapt the media information log to include one or more portions of available media information. The algorithm may assign weights to the plurality of codes. The algorithm may apply the weights to those portions of available media information with removed conflicts. The algorithm may be used to identify which of the portions of available media information with removed conflicts to assign to a respective available slot.

The algorithm may assign the priority code with the highest relative priority of the plurality of codes. For example, available media information with removed conflict(s) having the highest priority code will be assigned to the available slot. The code with the next highest relative priority may be the rate code. For example, when two or more portions of available media information have the same priority code, the computing device may assign the portion of available media information having the highest rate code to the available slot. The code with the next highest relative priority (e.g., after the rate code) may be the length code. For example, when two or more portions of available media information have the same priority code and the same rate code, the computing device may assign the portion of available media information that has the greatest length to the available slot. For example, the algorithm may assign a higher priority to a portion of available media information that is 30 seconds than a portion of available media information that is 15 seconds. This may be performed in an effort to enable placement of larger portions of media information that cannot be segmented, to allow for shorter portions of media information to be available for placement in shorter slots. When the media information log includes a plurality of available slots, the computing device may assign portions of available media information successively (e.g., iteratively) such that analysis of each assignment can be performed. For example, the assignment of available media information to available slots may be an iterative adaptive process performed by the computing device. The algorithm may determine to assign a first portion of available media information to a first available slot and then may determine to assign a second portion of available media information to a second available slot, and so on until each available slot is scheduled (e.g., has media information assigned). Additionally or alternatively, the algorithm may determine to assign the available media information to the available slot(s) based on a match between the break detail code of the available slot and the break detail code of the available media information.

At 420, the computing device may generate a revised media information log. The revised media information log may include one or more portions of the available media information in the one or more available slots. The computing device may determine a start date and/or an end date for the revised media information log. For example, the computing device may determine how long the revised media information log should be used.

The predetermined period may be adjustable. For example, the computing device may determine an end (e.g., a length) of the predetermined period. The computing device may determine the end of the predetermined period based on a user input. The end of the predetermined period may comprise an end date. Additionally or alternatively, the computing device may determine a start of the predetermined period. The computing device may determine the end of the predetermined period based on a user input. The start of the predetermined period may comprise a start date. For example, a user may determine whether to lengthen or shorten the predetermined period. By adjusting the start date and/or end date, the computing device can determine how long to use the revised media information log. Additionally or alternatively, the computing device may determine whether to lengthen or shorten the predetermined period.

After generating the revised media information log, at 420, the computing device may perform a recycle procedure. As part of the recycle procedure, the computing device may identify unplaced media information. The unplaced media information may include available media information that was not placed in the revised information log and/or previously scheduled media information that was displaced from the revised information log. The recycle procedure may include repeating the example method 400. For example, the computing device may be configured to repeat steps 406-420 of the example method 400 in the recycle procedure. The recycle procedure may be used by the computing device to determine whether available media information and/or displaced media information can be scheduled in the revised media information log. For example, the recycle procedure may be used by the computing to determine whether media information displaced later in the predetermined period (e.g., a later day in the predetermined period) can be scheduled earlier in the predetermined period (e.g., an earlier day in the predetermined period). The computing device may identify one or more portions of displaced media information that can be scheduled in an earlier slot (e.g., earlier in the predetermined period than the slot from which the one or more portions of displaced media information were displaced from) of the revised information log.

At 422, the computing device may send the revised media information log to another computing device (e.g., the computing device that sent the initial media information log) associated with the administrative user. The computing device may send the revised media information log via the wireless connection with the other computing device or via the wired connection with the other computing device. The computing device may include one or more of the start date or the end date to the other computing device, for example, with the revised media information log. For example, the computing device may send the revised media information log to the other computing device via the network (e.g., such as the network 220 shown in FIG. 2).

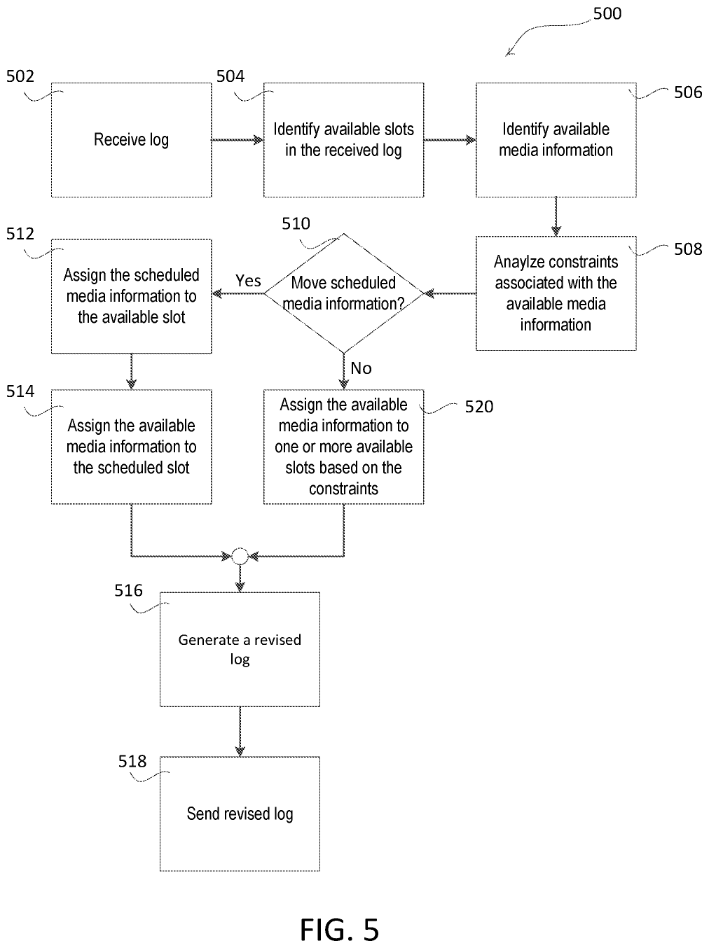

FIG. 5 is a flow diagram of an example method 500 that may be implemented by a computing device (e.g., such as the computing devices 230a-230n shown in FIG. 2) to generate a revised media information log by moving one or more portions of scheduled media information. The method 500, or portions thereof, may be performed to enable adaptive media traffic management of a media channel. The adaptive media traffic management may include placement of media information in slots of a media information log. Media information may include news reports, sports reports, music (e.g., songs), programs, and/or advertisements. The method 500, or portions thereof, may be performed at a single computing device or may be distributed across multiple computing devices (e.g., a server and a user device). The method 500, or portions thereof, may be performed to enable users, such as administrative users, to identify available slots, available media information, and assign the available media information to the available slots. The method 500, or portions thereof, may be performed to enable adaptive generation of a revised media information log that includes the available media information, or portions thereof, in respective slots. The method 500, or portions thereof, may reduce the amount of processing resources used by the computing device during a predetermined period (e.g., day). The method 500, or portions thereof, may improve the functionality of a computer network system (e.g., such as the computing network system 200 shown in FIG. 2) associated with the adaptive media traffic management of the media channel. In addition, the method 500, or portions thereof, implement a distributed network architecture, as shown in FIG. 2, to reduce the amount of signaling between the computing device and an administrative computing device (e.g., such as the computing device 210 shown in FIG. 2) and reduce the amount of processing resources consumed by the administrative computing device. The method 500, or portions thereof, may be combined with the method 300 and/or the method 400.

As illustrated in FIG. 5, a computing device may receive, at 502, a media information log. The media information log may be associated with a media channel. The media channel may be a radio station, a radio network, a television station, a television network, a webcast, a streaming station, a streaming channel, a digital publisher, a social media channel, a social media platform, and/or the like. The media information log may be received from another computing device (e.g., such as the computing device 210 shown in FIG. 2). The other computing device may be associated with an administrative user. The computing device may receive the media information log via a wireless connection with the other computing device or via a wired connection with the other computing device. For example, the computing device may receive the media information log from the other computing device via a network (e.g., such as the network 220 shown in FIG. 2). The media information log may indicate slots (e.g., time slots) and scheduled portions of media information assigned to the slots for a predetermined period (e.g., a 24 hour period or a day). Each of the slots may be associated with a portion of the predetermined period. For example, each of the slots may represent even or uneven segments of the predetermined period. In examples, each slot is assigned a length of time according to the daily schedule. In examples, each slot is assigned the same length of time (e.g., 10 seconds) and slots are combined to create slots having a longer length. Each of the scheduled portions of media information may be scheduled to be broadcast via the media channel in their respective slots. A scheduled portion of media information may include a news report, music (e.g., a song), a weather forecast, a program, and/or an advertisement.

Each of the scheduled portions of media information may be associated with a plurality of codes. The media information log may indicate the plurality of codes. The plurality of codes may indicate one or more characteristics associated with the corresponding scheduled portions of media information. For example, the plurality of codes may include one or more of a priority code, a product code, a day locked code, a slot locked code, a media information type code, a position code, a break detail code, a slot number code, an advertiser separation code, a brand separation code, a product separation code, a length code, an exclusivity code, or a rate code.

The computing device may identify, at 504, one or more available slots in the received media information log. For example, the received media information log may indicate that media information is not assigned to the one or more available slots. The computing device may analyze the received media information log to determine the one or more available slots. For example, the computing device may identify, at 504, based on analysis of the received media information log, the one or more available slots in the predetermined period. The computing device may identify, at 504, one or more available slots based on a determination of unscheduled time in adjacent blocks having the same block detail code, as described herein. For example, the computing device may determine that unscheduled time in adjacent blocks can be combined (e.g., when the adjacent blocks have the same block detail code) to create an available slot.

Additionally or alternatively, the computing device may remove scheduled media information having a priority (e.g., priority code) below a threshold priority (e.g., threshold priority code) from the media information log. For example, the computing device may remove the low priority scheduled media information prior to identifying, at 504, the available slot(s) in the media information log such that the slots vacated by the removed scheduled media information are determined to be available slots. The removal from the media information log of scheduled media information having a priority code below a threshold priority code may be performed automatically by the computing device, for example, upon receipt of the media information log. Removing the low priority scheduled media information may result in time savings in generating a revised log, reduce the number of calculations performed to generate the revised log, and/or improve processor efficiency.

At 506, the computing device may identify available (e.g., unscheduled portions of) media information. For example, the computing device may receive an unscheduled media information list that indicates one or more (e.g., a plurality of) portions of available media information. The available media information may be available to schedule in the one or more available slots in the predetermined period. The unscheduled media information list may indicate values of the plurality of codes for the available media information. An available (e.g., unscheduled) portion of media information may include a news report, music (e.g., a song), a weather forecast, a program, and/or an advertisement.

At 508, the computing device may analyze constraints associated with the available media information. For example, the computing device may store a list of constraints for one or more of the plurality of codes. The constraints in the list may have values that differ from the values indicated in the unscheduled media information list. The computing device may compare the constraints (e.g., the values of the constraints) against the values indicated in the unscheduled media information list.

At 510, the computing device may determine whether to move one or more portions of scheduled media information, for example, to the available slot(s). For example, the computing device may identify one or more portions of scheduled media information that can be moved to the available slot(s). The computing device may analyze one or more conflicts associated with the one or more portions of scheduled media information and the available slot(s) (e.g., scheduled portions of media information proximate to the available slot(s)). The computing device may determine, at 510, to move at least one portion of scheduled media information to the available slot based on the conflicts analysis. When the conflicts analysis identifies a conflict between the at least one portion of scheduled media information and the available slot, the computing device may adjust one or more constraints associated with the at least one portion of scheduled media information, for example, to remove the conflict. The computing device may adjust the adjustable constraint(s) to generate one or more adjusted constraints. The computing device may adjust the adjustable constraint(s) based on a respective determined modification range. The modification range may be determined by the computing device as described herein. The computing device may adjust the adjustable constraint(s) to remove (e.g., negate) the determined conflict such that the scheduled media information can be assigned to the available slot(s). For example, the computing device may adjust an adjustable constraint for a portion of scheduled media information within the modification range such that the portion of scheduled media information can be assigned to a specific available slot.

At 512, the computing device may assign (e.g., automatically assign) one or more portions of scheduled media information from a scheduled slot to the available slot(s). For example, the computing device may use the conflicts analysis and/or a weighting algorithm to determine which portion(s) of scheduled media information to assign to the available slot(s). When two or more portions of scheduled media information are available (e.g., conflicts associated with the two or more portions of scheduled media information have been negated) to move to a specific available slot, the computing device may use the weighting algorithm that assigns weights to the plurality of codes to determine which portion of scheduled media information to move to the specific available slot. The computing device may move one or more portions of scheduled media information from one or more scheduled slots to one or more available slots, for example, to open up the one or more scheduled slots for unscheduled portions of media information. For example, moving the one or more portions of scheduled media information may enable optimized placement (e.g., scheduling) of the unscheduled portions of media information.

As described herein, the weighting algorithm may assign the priority code the highest relative priority of the plurality of codes. For example, a portion of scheduled media information with removed conflict(s) having the highest priority code will be assigned to the available slot. The code with the next highest relative priority in the weighting algorithm may be the rate code. For example, when two or more portions of scheduled media information have the same priority code, the computing device may assign the portion of scheduled media information having the highest rate code to the available slot. The code with the next highest relative priority (e.g., after the rate code) in the weighting algorithm may be the length code. For example, when two or more portions of scheduled media information have the same priority code and the same rate code, the computing device may assign the portion of scheduled media information that has the greatest length to the available slot. For example, the weighting algorithm may assign a higher priority to a portion of scheduled media information that is 30 seconds in length than a portion of scheduled media information that is 15 seconds or shorter (e.g., when the available slot is 30 seconds or longer in length). In other examples, the weighting algorithm may assign a higher priority to a portion of scheduled media information with the shortest length. When the available slot is 15 seconds, the weighting algorithm may assign a higher priority to a portion of scheduled media information that is 15 seconds in length than a portion of scheduled media information that is 30 seconds or longer in length. An example priority order applied by the weighting algorithm for an available slot (e.g., each available slot) may include the following order from highest priority to lowest priority: the priority code, the rate code, the length code, the day locked code, the slot locked code, the product code, the media information type code, the position code, the slot number code, the advertiser separation code, the brand separation code, the product separation code, and the exclusivity code.

At 514, the computing device may assign (e.g., automatically assign) one or more portions of the available media information to the scheduled slot vacated by the portion of scheduled media information that was moved to the available slot. For example, the computing device may assign the available media information to the scheduled slot based on the stored constraints (e.g., comparison of the constraints and the values indicated in the unscheduled media information list). The computing device may identify one or more of the values indicated in the unscheduled media information list that can be adjusted such that the available media information associated with the one or more values can be assigned to the scheduled slot. For example, the computing device may adjust the one or more values indicated in the unscheduled media information toward the values of the constraints until the available media information can be assigned to the scheduled slot. In other examples, one or more portions of the available media information may be conflict free with respect to the scheduled slot. When two or more portions of the available media information have no conflict with the scheduled slot, the computing device may use the weighting algorithm to determine which of the conflict free portions of available media information to assign to the scheduled slot. Additionally or alternatively, the computing device may assign the available media information to the available slot(s) based on a match between the break detail code of the available slot and the break detail code of the available media information.

When the computing device determines to not move any portions of scheduled media information, the computing device may assign (e.g., automatically assign), at 520, one or more portions of the available media information to the one or more available slots. For example, the computing device may assign the available media information to the available slots based on the stored constraints (e.g., comparison of the constraints and the values indicated in the unscheduled media information list). The computing device may identify one or more of the values indicated in the unscheduled media information list that can be adjusted such that the available media information associated with the one or more values can be assigned to an available slot. For example, the computing device may adjust the one or more values indicated in the unscheduled media information toward the values of the constraints until the available media information can be assigned to an available slot. Additionally or alternatively, the computing device may assign, at 520, the available media information to the available slot(s) based on a match between the break detail code of the available slot and the available media information.

At 516, the computing device may generate a revised media information log. The revised media information log may include one or more portions of the available media information in the one or more available slots and/or one or more scheduled slots. The revised media information log may include one or more portions of scheduled media information in the one or more available slots. The computing device may determine a start date and/or an end date for the revised media information log. For example, the computing device may determine how long the revised media information log should be used.

The predetermined period may be adjustable. For example, the computing device may determine an end (e.g., a length) of the predetermined period. The computing device may determine the end of the predetermined period based on a user input. The end of the predetermined period may comprise an end date. Additionally or alternatively, the computing device may determine a start of the predetermined period. The computing device may determine the end of the predetermined period based on a user input. The start of the predetermined period may comprise a start date. For example, a user may determine whether to lengthen or shorten the predetermined period. By adjusting the start date and/or end date, the computing device can determine how long to use the revised media information log. Additionally or alternatively, the computing device may determine whether to lengthen or shorten the predetermined period.

After generating the revised media information log, at 516, the computing device may perform a recycle procedure. As part of the recycle procedure, the computing device may identify unplaced media information. The unplaced media information may include available media information that was not placed in the revised information log and/or previously scheduled media information that was displaced from the revised information log. The recycle procedure may include repeating the example method 500. For example, the computing device may be configured to repeat steps 504-516 of the example method 500 in the recycle procedure. The recycle procedure may be used by the computing device to determine whether available media information and/or displaced media information can be scheduled in the revised media information log. For example, the recycle procedure may be used by the computing to determine whether media information displaced later in the predetermined period (e.g., a later day in the predetermined period) can be scheduled earlier in the predetermined period (e.g., an earlier day in the predetermined period). The computing device may identify one or more portions of displaced media information that can be scheduled in an earlier slot (e.g., earlier in the predetermined period than the slot from which the one or more portions of displaced media information were displaced from) of the revised information log.

At 518, the computing device may send the revised media information log to another computing device (e.g., the computing device that sent the initial media information log) associated with the administrative user. The computing device may send the revised media information log via the wireless connection with the other computing device or via the wired connection with the other computing device. The computing device may include one or more of the start date or the end date to the other computing device, for example, with the revised media information log. For example, the computing device may send the revised media information log to the other computing device via the network (e.g., such as the network 220 shown in FIG. 2).

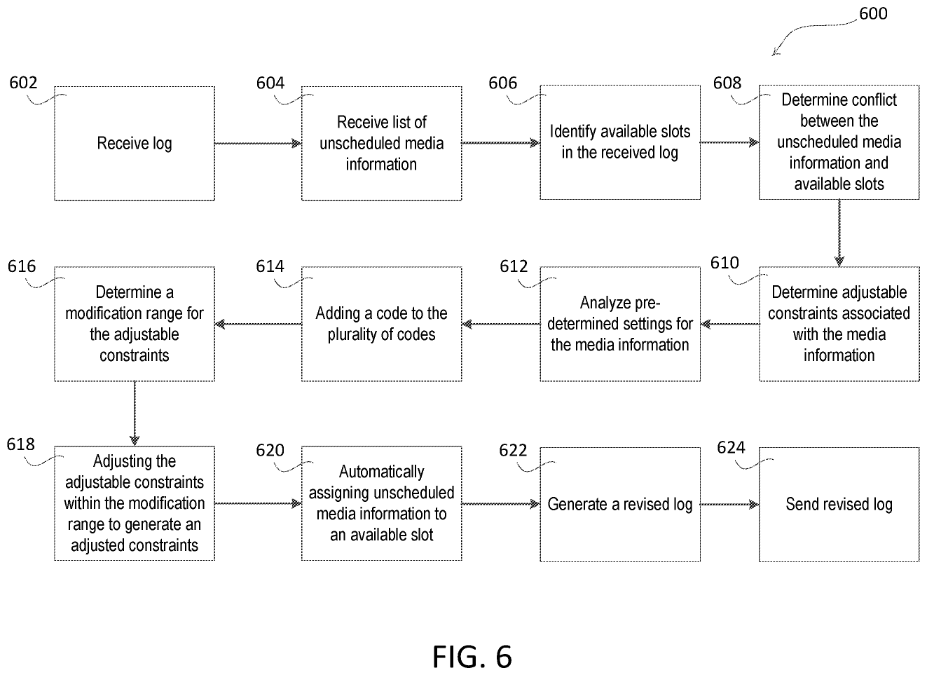

FIG. 6 is a flow diagram of an example method 400 that may be implemented by a computing device (e.g., such as the computing devices 230a-230n shown in FIG. 2) to generate a revised media information log by adding a code. The code may be added to enable adjustment of another code. The method 600, or portions thereof, may be performed to enable adaptive media traffic management of a media channel. The adaptive media traffic management may include placement of media information in slots of a media information log. Media information may include news reports, sports reports, music (e.g., songs), programs, and/or advertisements. The method 600, or portions thereof, may be performed at a single computing device or may be distributed across multiple computing devices (e.g., a server and a user device). The method 600, or portions thereof, may be performed to enable users, such as administrative users, to identify available slots, available media information, and assign the available media information to the available slots. The method 600, or portions thereof, may be performed to enable adaptive generation of a revised media information log that includes the available media information, or portions thereof, in respective slots. The method 600, or portions thereof, may reduce the amount of processing resources used by the computing device during a predetermined period (e.g., day). The method 600, or portions thereof, may improve the functionality of a computer network system (e.g., such as the computing network system 200 shown in FIG. 2) associated with the adaptive media traffic management of the media channel. In addition, the method 600, or portions thereof, implement a distributed network architecture, as shown in FIG. 2, to reduce the amount of signaling between the computing device and an administrative computing device (e.g., such as the computing device 210 shown in FIG. 2) and reduce the amount of processing resources consumed by the administrative computing device. The method 600, or portions thereof, may be combined with the method 300, the method 400, and/or the method 500.

As illustrated in FIG. 6, a computing device may receive, at 602, a media information log. The media information log may be associated with a media channel. The media channel may be a radio station, a radio network, a television station, a television network, a webcast, a streaming station, a streaming channel, a digital publisher, a social media channel, a social media platform, and/or the like. The media information log may be received from another computing device (e.g., such as the computing device 210 shown in FIG. 2). The other computing device may be associated with an administrative user. The computing device may receive the media information log via a wireless connection with the other computing device or via a wired connection with the other computing device. For example, the computing device may receive the media information log from the other computing device via a network (e.g., such as the network 220 shown in FIG. 2). The media information log may indicate slots (e.g., time slots) and scheduled portions of media information assigned to the slots for a predetermined period (e.g., a 24 hour period or a day). Each of the slots may be associated with a portion of the predetermined period. For example, each of the slots may represent even or uneven segments of the predetermined period. In examples, each slot is assigned a length of time according to the daily schedule. In examples, each slot is assigned the same length of time (e.g., 10 seconds) and slots are combined to create slots having a longer length. Each of the scheduled portions of media information may be scheduled to be broadcast via the media channel in their respective slots. A scheduled portion of media information may include a news report, music (e.g., a song), a weather forecast, a program, and/or an advertisement.

Each of the scheduled portions of media information may be associated with a plurality of codes. The media information log may indicate the plurality of codes. The plurality of codes may indicate one or more characteristics associated with the corresponding scheduled portions of media information. For example, the plurality of codes may include one or more of a priority code, a product code, a day locked code, a slot locked code, a media information type code, a position code, a break detail code, a slot number code, an advertiser separation code, a brand separation code, a product separation code, a length code, an exclusivity code, or a rate code.

At 604, the computing device may receive an unscheduled media information list. The unscheduled media information list may indicate one or more (e.g., a plurality of) available (e.g., unscheduled portions of) media information. The available media information may be available to schedule in the one or more available slots in the predetermined period. The unscheduled media information list may indicate values of the plurality of codes for the available media information. An available (e.g., unscheduled) portion of media information may include a news report, music (e.g., a song), a weather forecast, a program, and/or an advertisement.

The computing device may identify, at 606, one or more available slots in the received media information log. For example, the received media information log may indicate that media information is not assigned to the one or more available slots. The computing device may analyze the received media information log to determine the one or more available slots. For example, the computing device may identify, at 606, based on analysis of the received media information log, the one or more available slots in the predetermined period. The computing device may identify, at 606, one or more available slots based on a determination of unscheduled time in adjacent blocks having the same block detail code, as described herein. For example, the computing device may determine that unscheduled time in adjacent blocks can be combined (e.g., when the adjacent blocks have the same block detail code) to create an available slot.

Additionally or alternatively, the computing device may remove scheduled media information having a priority (e.g., priority code) below a threshold priority (e.g., threshold priority code) from the media information log. For example, the computing device may remove the low priority scheduled media information prior to identifying, at 606, the available slot(s) in the media information log such that the slots vacated by the removed scheduled media information are determined to be available slots. The removal from the media information log of scheduled media information having a priority code below a threshold priority code may be performed automatically by the computing device, for example, upon receipt of the media information log. Removing the low priority scheduled media information may result in time savings in generating a revised log, reduce the number of calculations performed to generate the revised log, and/or improve processor efficiency.

At 608, the computing device may determine one or more conflicts between the available media information and the one or more available slots. The conflicts may be associated with one or more scheduled portions of media information proximate to an available slot. One or more scheduled portions of media information within the same block, the same hour block, and/or a predetermined period may be considered to be proximate to the available slot. For example, the conflicts may be associated with values of the plurality of codes for the available media information and values of the plurality of codes for scheduled media information proximate to the respective available slots. The computing device may determine, at 608, a conflict for a portion of available media information for an available slot based on a comparison of the values of the plurality of codes for the portion of available media information and the values of the plurality of codes for scheduled portions of media information proximate to the available slot.

When the length of the available slot is less than the length of a portion of available media information, the computing device may determine a length conflict between the available slot and the portion of available media information. When a time separation between the available slot and a scheduled portion of media information associated with a related product is less than a value for the product separation code associated with a portion of available media information, the computing device may determine a product conflict between the available slot and the portion of available media information. The computing device may determine that a product is related based on the product code. When a time separation between the available slot and a scheduled portion of media information associated with a competitor advertiser is less than a value for the advertiser separation code associated with a portion of available media information, the computing device may determine an advertiser conflict between the available slot and the portion of available media information. When a time separation between the available slot and a scheduled portion of media information associated with a related brand is less than a value for the brand separation code associated with a portion of available media information, the computing device may determine a brand conflict between the available slot and the portion of available media information. When a time separation between the available slot and a scheduled portion of media information associated with an advertiser associated with a portion of available media information is less than a value for the product separation code associated with the portion of available media information, the computing device may determine an advertiser conflict between the available slot and the portion of available media information.

When the available slot is in the same block as a scheduled portion of media information associated with an advertiser associated with a portion of available media information, the computing device may determine an advertiser conflict between the available slot and the portion of available media information. When the available slot is in the same block as a scheduled portion of media information associated with a competitor advertiser associated with a portion of available media information, the computing device may determine an advertiser conflict between the available slot and the portion of available media information. When the available slot is in the same block as a scheduled portion of media information associated with a competitor product associated with a portion of available media information, the computing device may determine a product conflict between the available slot and the portion of available media information. When the available slot is in the same block as a scheduled portion of media information associated with a brand associated with a portion of available media information, the computing device may determine a brand conflict between the available slot and the portion of available media information.

At 610, the computing device may determine, for each of the determined conflicts, one or more adjustable constraints associated with the values of the plurality of codes indicated for the available media information. The one or more adjustable constraints may include time based separation constraints associated with the block based separation codes and/or block based separation constraints associated with the block based separation codes. The one or more adjustable constraints may be adjusted for one or more of the unscheduled portions of media information, for example, to remove the conflict. For example, the computing device may determine that a time based separation and/or a block based separation associated with the available media information and the available slots can be adjusted. In examples, the computing device may determine that a length (e.g., 5 minutes) of the time based separation constraint can be adjusted. In examples, the computing device may determine that a block based separation constraint can be adjusted. For example, the computing device may determine that a block based separation constraint can be converted to a time based separation constraint.

At 612, the computing device may analyze one or more pre-determined settings for the available media information. For example, the computing device may store the pre-determined settings for the available media information. The computing device may also store pre-determined settings for the scheduled media information. The pre-determined settings may represent a limit (e.g., an adjustment limit) for the values of the plurality of codes. For example, the pre-determined settings may (e.g., and the limit) for each of the values of the plurality of codes for a specific portion of media information may be based on contractual obligations associated with an advertiser of the specific portion of media information.

At 614, the computing device may add a code to the plurality of codes. The computing device may determine that adding the code to the plurality of codes enables greater flexibility in assigning one or more portions of available media information. For example, the added code may enable modification of a related constraint of the one or more adjustable constraints. The added code may be an hour block code. The hour block code may indicate a specific hour block (e.g., 7-8 am, 8-9 am, etc.) in the predetermined period. The related constraint may be a time separation constraint (e.g., associated with a time separation code). Adding the code to the plurality of codes may enable greater flexibility in adjustment of a constraint (e.g., the time separation constraint). In another example, the added code may be a block detail code. The block detail code may identify a specific block and/or a specific block type within the log. For example, each block in the log may be assigned a block detail code. A specific portion (e.g., scheduled or unscheduled) of media information may be constrained to a specific block and/or block type using the block detail code. The block detail code may restrict combination of time in adjacent blocks. For example, if adjacent blocks have different block detail codes, time from those adjacent blocks cannot be combined to create a slot with a longer duration. Adding the block detail code to the plurality of codes may avoid assigning a portion of available media information to a block with break details that do not match the portion of available media information. Adding the block detail code may enable combination of time in adjacent blocks having the same block detail code to create a new slot (e.g., a new available slot) and/or extend the duration of an available slot. For example, 5 seconds from a first block may be combined with 25 seconds from a second block to create a 30 second slot when the first block and the second block have the same block detail code.

At 616, the computing device may determine a modification range for the related constraint. The modification range may be determined, at 616, based on the pre-determined settings and the added code. For example, the modification range may be determined as the range between the values indicated in the available media information list and the limit stored in the pre-determined settings. The available media information list may indicate a value for each of the plurality of codes for a specific portion of available media information. The computing device may determine modification ranges for one or more of the plurality of codes based on the limits stored for each of the plurality of codes associated with the specific portion of available media information. When the added code is the hour block code and the related constraint is a time separation constraint, the modification range for the related constraint may be 30-45 minutes.

At 618, the computing device may adjust the related constraint. The computing device may adjust, at 618, the related constraint to generate an adjusted related constraint. The computing device may adjust, at 618, the related constraint based on the respective determined modification range. The computing device may adjust, 618, the related constraint to remove (e.g., negate) the determined conflict such that the available media information can be assigned to the available slot(s). For example, the computing device may adjust the related constraint from an initial value (e.g., 45 minutes) to a revised value representing a shorter time separation (e.g., 30 minutes). The initial value may be an initial range (e.g., a range of 45-60 minutes). The revised value may be a shorter range (e.g., a range of 30-45 minutes) than the initial range.

At 620, the computing device may assign (e.g., automatically assign) a portion of available media information to the available slot(s). The computing device may determine (e.g., automatically determine) which portion(s) of available media information to assign to the available slot(s), for example, when conflicts associated with an available slot and more than one portion of available media information have been removed. For example, the computing device may include an algorithm that assigns weights to the plurality of codes. The priority code may be assigned the highest relative priority of the plurality of codes. For example, available media information with negated conflict(s) having the highest priority code will be assigned to the available slot. The code with the next highest relative priority may be the rate code. For example, when two or more portions of available media information have the same priority code, the computing device may assign the portion of available media information having the highest rate code to the available slot. The code with the next highest relative priority (e.g., after the rate code) may be the length code. For example, when two or more portions of available media information have the same priority code and the same rate code, the computing device may assign the portion of available media information that has the greatest length to the available slot. For example, the algorithm may assign a higher priority to a portion of available media information that is 30 seconds than a portion of available media information that is 15 seconds. Additionally or alternatively, the computing device may assign, at 620, the available media information to the available slot(s) based on a match between the break detail code of the available slot and the available media information.

At 622, the computing device may generate a revised media information log. The revised media information log may include one or more portions of the available media information in the one or more available slots. The computing device may determine a start date and/or an end date for the revised media information log. For example, the computing device may determine how long the revised media information log should be used.

The predetermined period may be adjustable. For example, the computing device may determine an end (e.g., a length) of the predetermined period. The computing device may determine the end of the predetermined period based on a user input. The end of the predetermined period may comprise an end date. Additionally or alternatively, the computing device may determine a start of the predetermined period. The computing device may determine the end of the predetermined period based on a user input. The start of the predetermined period may comprise a start date. For example, a user may determine whether to lengthen or shorten the predetermined period. By adjusting the start date and/or end date, the computing device can determine how long to use the revised media information log. Additionally or alternatively, the computing device may determine whether to lengthen or shorten the predetermined period.

After generating the revised media information log, at 622, the computing device may perform a recycle procedure. As part of the recycle procedure, the computing device may identify unplaced media information. The unplaced media information may include available media information that was not placed in the revised information log and/or previously scheduled media information that was displaced from the revised information log. The recycle procedure may include repeating the example method 600. For example, the computing device may be configured to repeat steps 606-622 of the example method 600 in the recycle procedure. The recycle procedure may be used by the computing device to determine whether available media information and/or displaced media information can be scheduled in the revised media information log. For example, the recycle procedure may be used by the computing to determine whether media information displaced later in the predetermined period (e.g., a later day in the predetermined period) can be scheduled earlier in the predetermined period (e.g., an earlier day in the predetermined period). The computing device may identify one or more portions of displaced media information that can be scheduled in an earlier slot (e.g., earlier in the predetermined period than the slot from which the one or more portions of displaced media information were displaced from) of the revised information log.

At 624, the computing device may send the revised media information log to another computing device (e.g., the computing device that sent the initial media information log) associated with the administrative user. The computing device may send the revised media information log via the wireless connection with the other computing device or via the wired connection with the other computing device. The computing device may include one or more of the start date or the end date to the other computing device, for example, with the revised media information log. For example, the computing device may send the revised media information log to the other computing device via the network (e.g., such as the network 220 shown in FIG. 2).

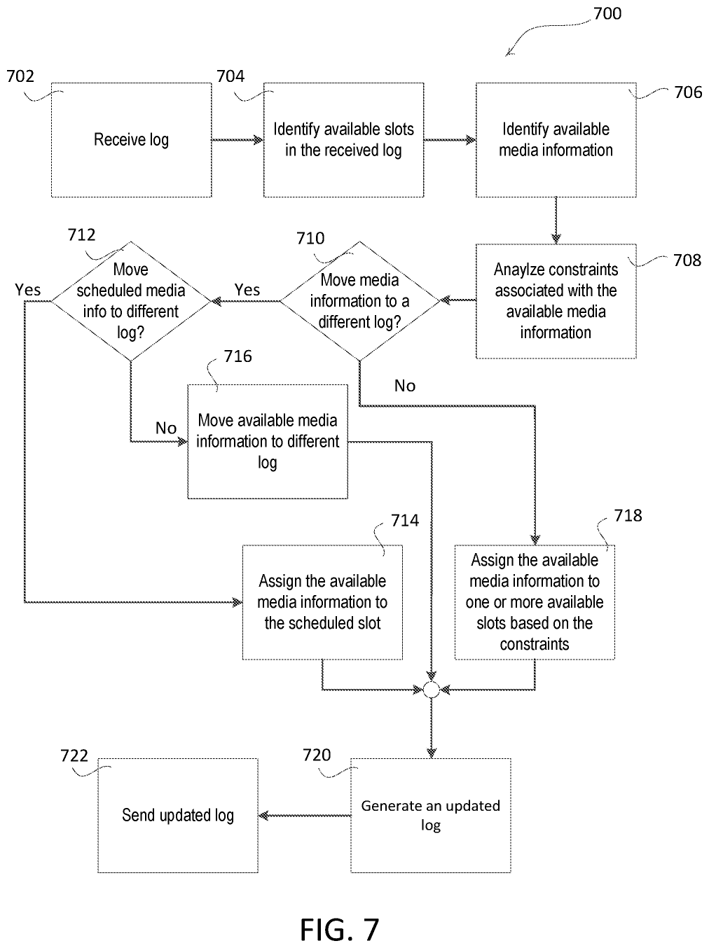

FIG. 7 is a flow diagram of an example method 700 that may be implemented by a computing device (e.g., such as the computing devices 230a-230n shown in FIG. 2) to generate a revised media information log by moving one or more portions of media information to another media information log (e.g., a future media information log). The method 700, or portions thereof, may be performed to enable adaptive media traffic management of a media channel. The adaptive media traffic management may include placement of media information in slots of a media information log. Media information may include news reports, sports reports, music (e.g., songs), programs, and/or advertisements. The method 700, or portions thereof, may be performed at a single computing device or may be distributed across multiple computing devices (e.g., a server and a user device). The method 700, or portions thereof, may be performed to enable users, such as administrative users, to identify available slots, available media information, and assign the available media information to the available slots. The method 700, or portions thereof, may be performed to enable adaptive generation of a revised media information log that includes the available media information, or portions thereof, in respective slots. The method 700, or portions thereof, may reduce the amount of processing resources used by the computing device during a predetermined period (e.g., day). The method 700, or portions thereof, may improve the functionality of a computer network system (e.g., such as the computing network system 200 shown in FIG. 2) associated with the adaptive media traffic management of the media channel. In addition, the method 700, or portions thereof, implement a distributed network architecture, as shown in FIG. 2, to reduce the amount of signaling between the computing device and an administrative computing device (e.g., such as the computing device 210 shown in FIG. 2) and reduce the amount of processing resources consumed by the administrative computing device. The method 700, or portions thereof, may be combined with the method 600, the method 500, the method 400, and/or the method 300.

As illustrated in FIG. 7, a computing device may receive, at 702, a media information log. The media information log may be associated with a media channel. The media channel may be a radio station, a radio network, a television station, a television network, a webcast, a streaming station, a streaming channel, a digital publisher, a social media channel, a social media platform, and/or the like. The media information log may be received from another computing device (e.g., such as the computing device 210 shown in FIG. 2). The other computing device may be associated with an administrative user. The computing device may receive the media information log via a wireless connection with the other computing device or via a wired connection with the other computing device. For example, the computing device may receive the media information log from the other computing device via a network (e.g., such as the network 220 shown in FIG. 2). The media information log may indicate slots (e.g., time slots) and scheduled portions of media information assigned to the slots for a predetermined period (e.g., a 24 hour period or a day). Each of the slots may be associated with a portion of the predetermined period. For example, each of the slots may represent even or uneven segments of the predetermined period. In examples, each slot is assigned a length of time according to the daily schedule. In examples, each slot is assigned the same length of time (e.g., 10 seconds) and slots are combined to create slots having a longer length. Each of the scheduled portions of media information may be scheduled to be broadcast via the media channel in their respective slots. A scheduled portion of media information may include a news report, music (e.g., a song), a weather forecast, a program, and/or an advertisement.

Each of the scheduled portions of media information may be associated with a plurality of codes. The media information log may indicate the plurality of codes. The plurality of codes may indicate one or more characteristics associated with the corresponding scheduled portions of media information. For example, the plurality of codes may include one or more of a priority code, a product code, a day locked code, a slot locked code, a media information type code, a position code, a break detail code, a slot number code, an advertiser separation code, a brand separation code, a product separation code, a length code, an exclusivity code, or a rate code.

The computing device may identify, at 704, one or more available slots in the received media information log. For example, the received media information log may indicate that media information is not assigned to the one or more available slots. The computing device may analyze the received media information log to determine the one or more available slots. For example, the computing device may identify, at 704, based on analysis of the received media information log, the one or more available slots in the predetermined period. The computing device may identify, at 704, one or more available slots based on a determination of unscheduled time in adjacent blocks having the same block detail code, as described herein. For example, the computing device may determine that unscheduled time in adjacent blocks can be combined (e.g., when the adjacent blocks have the same block detail code) to create an available slot.

Additionally or alternatively, the computing device may remove scheduled media information having a priority (e.g., priority code) below a threshold priority (e.g., threshold priority code) from the media information log. For example, the computing device may remove the low priority scheduled media information prior to identifying, at 704, the available slot(s) in the media information log such that the slots vacated by the removed scheduled media information are determined to be available slots. The removal from the media information log of scheduled media information having a priority code below a threshold priority code may be performed automatically by the computing device, for example, upon receipt of the media information log. Removing the low priority scheduled media information may result in time savings in generating a revised log, reduce the number of calculations performed to generate the revised log, and/or improve processor efficiency.

At 706, the computing device may identify available (e.g., unscheduled portions of) media information. For example, the computing device may receive an unscheduled media information list that indicates one or more (e.g., a plurality of) portions of available media information. The available media information may be available to schedule in the one or more available slots in the predetermined period. The unscheduled media information list may indicate values of the plurality of codes for the available media information. An available (e.g., unscheduled) portion of media information may include a news report, music (e.g., a song), a weather forecast, a program, and/or an advertisement.

At 708, the computing device may analyze constraints associated with the available media information. For example, the computing device may store a list of constraints for one or more of the plurality of codes. The constraints in the list may have values that differ from the values indicated in the unscheduled media information list. The computing device may compare the constraints (e.g., the values of the constraints) against the values indicated in the unscheduled media information list.

At 710, the computing device may determine whether to move media information to a different log (e.g., a future log). The different log may be a log for a future day (e.g., tomorrow). The computing device may determine, at 710, to move (e.g., automatically move) media information to a future log when an aggregate length of the available media information is greater than the aggregate length of the available slots. The computing device may determine, at 710, whether to move the media information to the future log based on a day locked code associated with the media information. For example, when a value of the day locked code for a specific portion of media information is set to “no” or “not locked,” the computing device may determine to move the specific portion of media information to the future log. The computing device may determine, at 710, whether to move the media information to the future log based on analysis of previous media information logs. For example, the computing device may determine, at 710, to not move the media information when the media information has not been scheduled in the past week of media information logs.

When the computing device determines to move media information to the future log, the computing device may determine, at 712, whether to move a scheduled portion of media information to the future log. The scheduled portion of media information may be in a scheduled slot. The scheduled portion of media information may be available to move to the future log when a value of the day locked code associated with the scheduled portion of media information is set to “no” or “not locked.” The scheduled portion of media information may be unavailable to move to the future log when the value of the day locked code associated with the scheduled portion of media information is set to “yes” or “locked.” The computing device may determine, at 712, to move the scheduled portion of media information based on the value of the day locked code associated with the scheduled portion of media information. The scheduled portion of media information may be proximate to one of the available slots. The computing device may determine, at 712, to move the scheduled portion of media information to the future log based on analysis of conflicts between the available media information and the one or more available slots. When the conflicts analysis identifies a conflict between the scheduled portion of media information and the available media information, the computing device may determine to move the scheduled portion of media information to the future log, for example, to remove the conflict. The computing device may determine, at 712, which portion of scheduled media information to move to the future log based on the weighting algorithm. For example, portions of scheduled media information having the lowest priority code of the priority codes may be moved to the future log.

When the computing device determines, at 712, to move the scheduled portion of media information to the future log, the computing device may assign (e.g., automatically assign), at 714, the available media information to the scheduled slot. The computing device may assign (e.g., automatically assign), at 714, one or more portions of the available media information to the scheduled slot vacated by the portion of scheduled media information that was moved to the future log. For example, the computing device may assign the available media information to the scheduled slot based on the stored constraints (e.g., comparison of the constraints and the values indicated in the unscheduled media information list). The computing device may identify one or more of the values indicated in the unscheduled media information list that can be adjusted such that the available media information associated with the one or more values can be assigned to the scheduled slot. For example, the computing device may adjust the one or more values indicated in the unscheduled media information toward the values of the constraints until the available media information can be assigned to the scheduled slot. In other examples, one or more portions of the available media information may be conflict free with respect to the scheduled slot. When two or more portions of the available media information have no conflict with the scheduled slot, the computing device may use the weighting algorithm to determine which of the conflict free portions of available media information to assign to the scheduled slot.

When the computing device determines, at 712, to not move the scheduled portion of media information to the future log, the computing device may move, at 716, one or more portions of available media information to the future log. The portion of available media information may be available to move to the future log when a value of the day locked code associated with the portion of available media information is set to “no” or “not locked.” The portion of available media information may be unavailable to move to the future log when the value of the day locked code associated with the portion of available media information is set to “yes” or “locked.” The computing device may determine, at 716, to move the portion of available media information to the future log based on the value of the day locked code associated with the portion of available media information.

When the computing device determines, at 710, to not move any media information to a future log, the computing device may assign (e.g., automatically assign), at 718, one or more portions of the available media information to the one or more available slots. For example, the computing device may assign, at 718, the available media information to the available slots based on the stored constraints (e.g., comparison of the constraints and the values indicated in the unscheduled media information list). The computing device may identify one or more of the values indicated in the unscheduled media information list that can be adjusted such that the available media information associated with the one or more values can be assigned to an available slot. For example, the computing device may adjust the one or more values indicated in the unscheduled media information toward the values of the constraints until the available media information can be assigned to an available slot. Additionally or alternatively, the computing device may assign, at 718, the available media information to the available slot(s) based on a match between the break detail code of the available slot(s) and the available media information.

At 720, the computing device may generate a revised media information log. The revised media information log may include one or more portions of the available media information in the one or more available slots and/or one or more scheduled slots. The revised media information log may include one or more portions of scheduled media information in the one or more available slots. The computing device may determine a start date and/or an end date for the revised media information log. For example, the computing device may determine how long the revised media information log should be used.

The predetermined period may be adjustable. For example, the computing device may determine an end (e.g., a length) of the predetermined period. The computing device may determine the end of the predetermined period based on a user input. The end of the predetermined period may comprise an end date. Additionally or alternatively, the computing device may determine a start of the predetermined period. The computing device may determine the end of the predetermined period based on a user input. The start of the predetermined period may comprise a start date. For example, a user may determine whether to lengthen or shorten the predetermined period. By adjusting the start date and/or end date, the computing device can determine how long to use the revised media information log. Additionally or alternatively, the computing device may determine whether to lengthen or shorten the predetermined period.

After generating the revised media information log, at 720, the computing device may perform a recycle procedure. As part of the recycle procedure, the computing device may identify unplaced media information. The unplaced media information may include available media information that was not placed in the revised information log and/or previously scheduled media information that was displaced from the revised information log. The recycle procedure may include repeating the example method 700. For example, the computing device may be configured to repeat steps 704-720 of the example method 700 in the recycle procedure. The recycle procedure may be used by the computing device to determine whether available media information and/or displaced media information can be scheduled in the revised media information log. For example, the recycle procedure may be used by the computing to determine whether media information displaced later in the predetermined period (e.g., a later day in the predetermined period) can be scheduled earlier in the predetermined period (e.g., an earlier day in the predetermined period). The computing device may identify one or more portions of displaced media information that can be scheduled in an earlier slot (e.g., earlier in the predetermined period than the slot from which the one or more portions of displaced media information were displaced from) of the revised information log.

At 722, the computing device may send the revised media information log to another computing device (e.g., the computing device that sent the initial media information log) associated with the administrative user. The computing device may send the revised media information log via the wireless connection with the other computing device or via the wired connection with the other computing device. The computing device may include one or more of the start date or the end date to the other computing device, for example, with the revised media information log. For example, the computing device may send the revised media information log to the other computing device via the network (e.g., such as the network 220 shown in FIG. 2).

Although features and elements are described herein in particular combinations, each feature or element can be used alone or in any combination with the other features and elements. The methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), removable disks, and optical media such as CD-ROM disks, and digital versatile disks (DVDs).

What is claimed is:

1. A method comprising:
receiving a log associated with a media channel from a computing device associated with an administrative user, the log indicating a plurality of slots and a plurality of scheduled portions of media information to be broadcast via the media channel in the plurality of slots during a predetermined period, each of the scheduled portions of media information associated with a first plurality of values of a plurality of codes;
receiving a list indicating a plurality of unscheduled portions of media information, the list indicating a second plurality of values of the plurality of codes associated with each of the plurality of unscheduled portions of media information;
identifying, based on analysis of the log, an available slot of the plurality of slots in the predetermined period;
determining a conflict between each of the unscheduled portions of media information and the available slot, wherein the conflict for each of the unscheduled portions of media information is associated with one or more of the second plurality of values and the plurality of scheduled portions of media information;
determining, based on analysis of the list, one or more first adjustable constraints associated with the second plurality of values that can be adjusted for one or more of the plurality of unscheduled portions of media information to remove the conflict;
determining, based on analysis of pre-determined settings for each of the plurality of unscheduled portions of media information, a modification range for each of the one or more first adjustable constraints;
adjusting, based on the plurality of scheduled portions of media information and the available slot, at least one of the one or more first adjustable constraints within the respective modification range to generate one or more first adjusted constraints;
automatically assigning, based on analysis of the second plurality of values, the first plurality of codes, and the one or more first adjusted constraints, a first unscheduled portion of the plurality of unscheduled portions of media information to the available slot;
generating a revised log that comprises the first unscheduled portion of media information in the available slot; and
sending the revised log to the computing device associated with the administrative user.

2. The method of claim 1, further comprising:
determining, based on the one or more adjustable constraints, that two or more of the plurality of unscheduled portions of media information are available to assign to the available slot;
weighting the second plurality of codes based on a priority code, a rate, a length, and a product type, wherein the first unscheduled portion of the plurality of unscheduled portions of media information is automatically assigned based on the weighting of the second plurality of codes.

3. The method of claim 2, wherein the priority code is weighted with the highest priority of the second plurality of codes

4. The method of claim 2, further comprising determining, based on analysis of the log, that one or more adjustable constraints associated with the first plurality of codes are adjustable for at least a first scheduled portion of the plurality of scheduled portions of media information, wherein the first scheduled portion is scheduled in a first scheduled slot.

5. The method of claim 4, wherein the available slot is a first available slot and the modification range is a first modification range; and wherein the method further comprises:
determining, based on analysis of pre-determined settings for the first scheduled portion of the plurality of scheduled portions of media information, a second modification range for each of the one or more second adjustable constraints associated with the first scheduled portion of the plurality of scheduled portions of media information; and
adjusting, based on the plurality of scheduled portions of media information and the available slot, at least one of the one or more second adjustable constraints within the respective modification range to generate one or more second adjusted constraints.

6. The method of claim 5, further comprising:
automatically moving the first scheduled portion to a second available slot; and
automatically assigning, based on analysis of the second plurality of codes, the first plurality of codes, and the one or more second adjusted constraints, a second unscheduled portion of the plurality of unscheduled portions of media information to the first scheduled slot.

7. The method of claim 5, wherein the log is a first log and the predetermined period is a first predetermined period, and wherein the method further comprises automatically moving the first scheduled portion of the plurality of scheduled portions of media information to a second log associated with a second predetermined period.

8. The method of claim 1, wherein the log is a first log and the predetermined period is a first predetermined period, and wherein the method further comprises automatically moving, based on the second plurality of codes, one or more of the plurality of unscheduled portions of media information to a second log associated with a second predetermined period.

9. The method of claim 1, further comprising:
adding a code to the second plurality of codes that enables modification of a related constraint of the plurality of first adjustable constraints; and
modifying the related constraint to enable assigning the first unscheduled portion of media information to the available slot.

10. The method of claim 9, wherein the code is an hour block code, and wherein the related constraint is a time separation constraint.

11. The method of claim 10, wherein the time separation constraint is modified from an initial range of 45-60 minutes to a target range of 30-45 minutes.

12. The method of claim 1, further comprising:
identifying a second unscheduled portion that is longer than the available slot;
determining a scheduled portion of media information proximate to the available slot that can be moved to extend a length of the available slot.

13. The method of claim 1, wherein the plurality of codes comprises one or more of a priority code, a product code, a day locked code, a slot locked code, a media information type code, a position code, a slot number code, an advertiser separation code, a brand separation code, a product separation code, a length code, an exclusivity code, or a rate code.

14. The method of claim 1, wherein the log is a first log and the predetermined period is a first predetermined period, and wherein the method further comprises automatically moving a second unscheduled portion of the plurality of unscheduled portions of media information to a second log associated with the media channel.

15. The method of claim 14, wherein the first log comprises the scheduled media information for a first day and the second log comprises the scheduled media information for a second day.

16. A computing device:
comprising a processor configured to:
receive a log associated with a media channel from a computing device associated with an administrative user, the log indicating a plurality of slots and a plurality of scheduled portions of media information to be broadcast via the media channel in the plurality of slots during a predetermined period, each of the scheduled portions of media information associated with a first plurality of values of a plurality of codes;
receive a list indicating a plurality of unscheduled portions of media information, the list indicating a second plurality of values of the plurality of codes associated with each of the plurality of unscheduled portions of media information;
identify, based on analysis of the log, an available slot of the plurality of slots in the predetermined period;
determine a conflict between each of the unscheduled portions of media information and the available slot, wherein the conflict for each of the unscheduled portions of media information is associated with one or more of the second plurality of values and the plurality of scheduled portions of media information;
determine, based on analysis of the list, one or more first adjustable constraints associated with the second plurality of values that can be adjusted for one or more of the plurality of unscheduled portions of media information to remove the conflict;
determine, based on analysis of pre-determined settings for each of the plurality of unscheduled portions of media information, a modification range for each of the one or more first adjustable constraints;
adjust, based on the plurality of scheduled portions of media information and the available slot, at least one of the one or more first adjustable constraints within the respective modification range to generate one or more first adjusted constraints;
automatically assign, based on analysis of the second plurality of values, the first plurality of codes, and the one or more first adjusted constraints, a first unscheduled portion of the plurality of unscheduled portions of media information to the available slot;
generate a revised log that comprises the first unscheduled portion of media information in the available slot; and
send the revised log to the computing device associated with the administrative user.

17. The computing device of claim 16, wherein the processor is further configured to:
determine, based on the one or more adjustable constraints, that two or more of the plurality of unscheduled portions of media information are available to assign to the available slot;
weight the second plurality of codes based on a priority code, a rate, a length, and a product type, wherein the first unscheduled portion of the plurality of unscheduled portions of media information is automatically assigned based on the weighting of the second plurality of codes.

18. The computing device of claim 17, wherein the priority code is weighted with the highest priority of the second plurality of codes

19. The computing device of claim 17, wherein the processor is further configured to determine, based on analysis of the log, that one or more adjustable constraints associated with the first plurality of codes are adjustable for at least a first scheduled portion of the plurality of scheduled portions of media information, wherein the first scheduled portion is scheduled in a first scheduled slot.

20. The computing device of claim 19, wherein the available slot is a first available slot and the modification range is a first modification range; and wherein the processor is further configured to:
determine, based on analysis of pre-determined settings for the first scheduled portion of the plurality of scheduled portions of media information, a second modification range for each of the one or more second adjustable constraints associated with the first scheduled portion of the plurality of scheduled portions of media information; and
adjust, based on the plurality of scheduled portions of media information and the available slot, at least one of the one or more second adjustable constraints within the respective modification range to generate one or more second adjusted constraints.

21. The computing device of claim 20, wherein the processor is further configured to:
automatically move the first scheduled portion to a second available slot; and
automatically assign, based on analysis of the second plurality of codes, the first plurality of codes, and the one or more second adjusted constraints, a second unscheduled portion of the plurality of unscheduled portions of media information to the first scheduled slot.

22. The computing device of claim 20, wherein the log is a first log and the predetermined period is a first predetermined period, and wherein the processor is further configured to automatically move the first scheduled portion of the plurality of scheduled portions of media information to a second log associated with a second predetermined period.

23. The computing device of claim 16, wherein the log is a first log and the predetermined period is a first predetermined period, and wherein the processor is fighter configured to automatically move, based on the second plurality of codes, one or more of the plurality of unscheduled portions of media information to a second log associated with a second predetermined period.

24. The computing device of claim 16, wherein the processor is further configured to:
add a code to the second plurality of codes that enables modification of a related constraint of the plurality of first adjustable constraints; and
modify the related constraint to enable assigning the first unscheduled portion of media information to the available slot.

25. The computing device of claim 24, wherein the code is an hour block code, and wherein the related constraint is a time separation constraint.

26. The computing device of claim 25, wherein the time separation constraint is modified from an initial range of 45-60 minutes to a target range of 30-45 minutes.

27. The computing device of claim 16, wherein the processor is further configured to:
identify a second unscheduled portion that is longer than the available slot;
determine a scheduled portion of media information proximate to the available slot that can be moved to extend a length of the available slot.

28. The computing device of claim 16, wherein the plurality of codes comprises one or more of a priority code, a product code, a day locked code, a slot locked code, a media information type code, a position code, a slot number code, an advertiser separation code, a brand separation code, a product separation code, a length code, an exclusivity code, or a rate code.

29. The computing device of claim 16, wherein the log is a first log and the predetermined period is a first predetermined period, and wherein the processor is further configured to automatically move a second unscheduled portion of the plurality of unscheduled portions of media information to a second log associated with the media channel.

30. The computing device of claim 29, wherein the first log comprises the scheduled media information for a first day and the second log comprises the scheduled media information for a second day.
